(19) United States
(12) Patent Application Publication
(10) Pub. No.: US 2018/0224095 A1
(43) Pub. Date: Aug. 9, 2018

(54) RETROFIT BRACKET RING

(71) Applicant: Brandon Cohen, Vernon, CA (US)

(72) Inventor: Brandon Cohen, Vernon, CA (US)

(21) Appl. No.: 15/425,805

(22) Filed: Feb. 6, 2017

(51) Int. Cl. F21V 21/04; F21S 8/02; F21V 21/14

(52) U.S. Cl. CPC F21V 21/04; F21V 21/14; F21S 8/02

(57) ABSTRACT

A device, specifically a bracket ring, for retrofitting a recessed lighting fixture to provide structures for receiving torsion springs of a lighting module may include a first-structural-curved-member and a second-structural-curved-member that may be slidingly coupled to the first-structural-curved-member. When coupled, these structural-curved-members may form a central hole that may be sized and shaped to receive a portion of a lighting module. These structural-curved-members may be disposed with respect to a lighting-module-hole of the recessed lighting fixture so as not to obstruct portions of the lighting module inserted into lighting-module-hole. Each structural-curved-member may include a bracket and a torsion-spring-receiver. These brackets may be adjustable and may provide for attachment of the bracket ring to the recessed lighting fixture. And torsion springs attached to the lighting module may attach to the torsion-spring-receivers.

### TECHNICAL FIELD OF THE INVENTION

The present invention relates in general to installing lighting modules with torsion springs into recessed lighting fixtures without C-clips and more specifically to a device (e.g., a bracket ring) that permits existing recessed lighting fixtures without C-clips to be retrofitted so that a lighting module with torsion springs may be effectively attached (mounted) to the retrofitted recessed lighting fixture.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Presently, circa 2016, electricians installing lighting modules into recessed lighting fixtures often prefer to use a lighting module with torsion springs, as this speeds up the install and takes less of a toll on the electrician. This preference then typically requires that the recessed lighting fixture that is destined to be receiving the lighting module with torsion springs has appropriate structure for receiving and engaging these torsion springs. Traditionally this torsion spring receiving structure are “C-clips.”

However, many preexisting, older, and already installed recessed lighting fixtures do not have such C-clip torsion spring receiving structure. If lighting modules with torsion springs are to be used, then these preexisting, older, and already installed recessed lighting fixtures must either be replaced or they must be retrofitted to add in torsion spring receiving structure.

Replacing these preexisting, older, and already installed recessed lighting fixtures without such C-clip torsion spring receiving structure, is not a viable option where the goal is only to utilize lighting modules with torsion springs, as such replacement adds too much cost and time; which is not offset by subsequent increase in install efficiency by using lighting modules with torsion springs.

This leaves retrofitting these preexisting, older, and already installed recessed lighting fixtures without such C-clip torsion spring receiving structure to add in such structure as a possible viable solution to the desire to use lighting modules with torsion springs on such recessed lighting fixtures.

Several companies are making available products to retrofit certain recessed lighting fixture to add torsion spring receiver functionality. Juno Lighting makes available a retrofit kit, styled as “Juno Basics Series™ 6RLC Retrofit LED Trim.” However, this product has a problem by utilizing a linear (straight) bridge that passes directly over a lighting-module-hole in a given recessed lighting fixture, which means only lighting modules that are not too tall may be used with these products as this linear (straight) bridge will otherwise obstruct such lighting modules. It would be desirable to do away with such a linear (straight) bridge that interferes with the lighting-module-hole in the given recessed lighting fixture.

Cooper Lighting makes available a “ML7RAB Retrofit Adapter Band” for retrofitting certain recessed lighting fixtures that do not have torsion spring receivers. The ML7RAB Retrofit Adapter Band is a band with torsion spring receivers, wherein this band fits concentrically within the lighting-module-hole of certain recessed lighting fixtures. This band is mounted to the inside diameter of the lighting-module-hole of certain recessed lighting fixtures with a series of screws. Because screws are used to mount this band to the inside diameter of the lighting-module-hole of certain recessed lighting fixtures, this means that there must be structural material of that inside diameter of the lighting-module-hole for the screws to anchor into. This structural material, if present, must also bear the full load of the band product plus the lighting module with torsion springs and such structural material may not have designed for such loads. That is one problem with this band product. Additionally, not all recessed lighting fixtures will have such structural material in the lighting-module-hole for receiving screws and this represents a limitation of this band product. Further, the fact that mounting this band product to the recessed lighting fixture requires screwing screws into structural material also significantly increases both the install time and install labor to use this band product, which eliminates any install efficiencies that might be gained from using a lighting module with torsion springs. That is, if one is using this band product so that a lighting module with torsion springs may be used; one may be better off just using a lighting module without torsion springs because of the added time and added labor to install and mount this band product to the recessed lighting fixture.

Sea Gull Lighting makes available a pair of clips for retrofitting, styled as “RETROFIT C CLIPS ACCESSORY, Product No. 14610.” Functionally these pair of clips for retrofitting function similar to the above noted ML7RAB Retrofit Adapter Band, in that to use, these pair of clips must be screwed into structural material of the inside diameter of the lighting-module-hole of the recessed lighting fixture. Thus these clips suffer the same problems and limitations as noted with the ML7RAB Retrofit Adapter Band product.

There is a need in the art for a device that retrofits recessed lighting fixtures with structures for receiving torsion springs, but wherein this device does not obstruct the lighting-module-hole; and wherein install of this device to the recessed lighting fixture does not require screwing into structural material of the inside diameter of the lighting-module-hole of the recessed lighting fixture; and wherein install of this device to the recessed lighting fixture is relatively fast so as not to eliminate install efficiencies of using lighting modules with torsion springs.

It is to these ends that the present invention has been developed.

### BRIEF SUMMARY OF THE INVENTION

To minimize the limitations in the prior art, and to minimize other limitations that will be apparent upon reading and understanding the present specification, the present invention describes a device, specifically a bracket ring, for retrofitting a recessed lighting fixture to provide structures for receiving torsion springs of a lighting module. In some embodiments, this bracket ring may comprise a first-structural-curved-member and a second-structural-curved-member that may be (slidingly in some embodiments) coupled to the first-structural-curved-member; wherein when coupled, these structural-curved-members may form a central hole that may be sized and shaped to receive a portion of a lighting module and wherein this formed central hole may not obstruct the lighting module. In some embodiments, each structural-curved-member may comprise a bracket (e.g., a descending-bracket) and a torsion-spring-receiver. These brackets (which may be opposing in some embodiments) may be adjustable and may provide for attachment of the bracket ring to the recessed lighting fixture. In some embodiments, attachment of these brackets to the recessed lighting fixture may be removable. And torsion springs attached to the lighting module may attach to the torsion-spring-receivers.

It is an objective of the present invention to provide a device for retrofitting a recessed lighting fixture without existing torsion spring receivers, such that after retrofitting the recessed lighting fixture there will be structure for receiving torsion springs.

It is another objective of the present invention to provide a device for retrofitting a recessed lighting fixture that is fast to install to the recessed lighting fixture.

It is another objective of the present invention to provide a device for retrofitting a recessed lighting fixture that is easy to install to the recessed lighting fixture.

It is another objective of the present invention to provide a device for retrofitting a recessed lighting fixture that about equally distributes load of the device and a lighting module with torsion springs to the recessed lighting fixture in manner that the recessed lighting fixture can accommodate.

It is another objective of the present invention to provide a device for retrofitting a recessed lighting fixture wherein the device does not obstruct nor block a lighting-module-hole of the recessed lighting fixture, so that tall lighting modules may be utilized.

It is another objective of the present invention to provide a device for retrofitting a recessed lighting fixture where installation to the recessed lighting fixture does not involve compromising structural integrity of the recessed lighting fixture.

It is yet another objective of the present invention to provide a device for retrofitting a recessed lighting fixture where installation to the recessed lighting fixture does not require screwing screws into structural material of an inside diameter of the lighting-module-hole of the recessed lighting fixture.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1A may depict an exploded top perspective view of a bracket ring.

FIG. 1B may depict the bracket ring of FIG. 1A, assembled, from a top perspective view.

FIG. 1C may depict the bracket ring of FIG. 1A, assembled, from a top view.

FIG. 1D may depict the bracket ring of FIG. 1A, assembled, from a bottom view.

FIG. 1E may depict the bracket ring of FIG. 1A, assembled, from a back (rear) view.

FIG. 1F may depict the bracket ring of FIG. 1A, assembled, from a front view.

FIG. 1G may depict the bracket ring of FIG. 1A, assembled, from a left side view. (Note a right side view may be a mirror image of the left side view.)

FIG. 1H may depict the bracket ring of FIG. 1A, assembled, from another top perspective view. FIG. 1H may depict detail region H.

FIG. 1I may be a close up of detail region 1I from FIG. 1H.

FIG. 2A may depict a front view of a torsion spring.

FIG. 2B may depict a torsion spring removably attached to a torsion-spring-receiver of a structural-curved-member of a bracket ring, shown from a top perspective view.

FIG. 3A may depict a lighting module with attached torsion springs, shown from a side view.

FIG. 3B may depict the lighting module with torsion springs from FIG. 3A, but with the lighting module with attached torsion springs removably coupled to a bracket ring, shown from a top perspective view; wherein the torsion springs are fully engaged with torsion-spring-receivers of the bracket ring.

FIG. 3C may depict the lighting module with attached torsion springs removably coupled to the bracket ring from FIG. 3B, shown from a front view.

FIG. 3D may depict the lighting module with attached torsion springs removably coupled to the bracket ring from FIG. 3D, shown from a side view.

FIG. 3E may depict the lighting module with attached torsion springs removably coupled to the bracket ring from FIG. 3B, shown from a top view.

FIG. 4 may depict a lighting module with attached torsion springs removably coupled to a bracket ring, shown from a top perspective view; wherein a portion of the lighting module may be in a process of being inserted into a central hole of the bracket ring.

FIG. 5A may depict a side view of a bracket ring with brackets in one configuration.

FIG. 5B may depict a side view of the bracket ring of FIG. 5A, but with the brackets in a different configuration.

FIG. 5C may depict a side view of the bracket ring of FIG. 5A, with the brackets removably clamping portions of a recessed lighting fixture.

FIG. 5D may depict a bottom perspective view of the bracket ring of FIG. 5A, with the brackets removably clamping portions of the recessed lighting fixture. FIG. 5D may include detail region 5E.

FIG. 5E may be a close up view of detail region 5E.

FIG. 5F may depict a top view of a bracket ring (removably) installed into a recessed lighting fixture.

FIG. 5G may depict a side view of the bracket ring of FIG. 5A, with the brackets removably clamping portions of a recessed lighting fixture, but in FIG. 5G a lighting module with attached torsion springs may also be shown.

FIG. 6 may depict a flow diagram of methods of using and/or installing a bracket ring with a recessed lighting fixture and/or methods of using and/or installing a bracket ring with a lighting module with torsion springs.

### REFERENCE NUMERAL SCHEDULE

100 bracket ring 100
101 first-structural-curved-member 101
103 pair of terminal ends 103
105 first-descending-bracket 105
107 fixed-bracket 107
109 protruding tabs 109
111 upwards-protruding-tabs 111
113 slidable-bracket 113
115 different protruding tabs 115
117 screw 117
119 spring 119
121 screw hole 121
125 first-torsion-spring-receiver 125
127 tab 127
129 at least one slot 129
131 second-structural-curved-member 131
133 pair of different terminal ends 133
135 second-descending-bracket 135
137 fixed-bracket 137
139 protruding tabs 139
141 upwards-protruding-tabs 141
143 slidable-bracket 143
145 different protruding tabs 145
147 screw 147
149 spring 149
151 screw hole 151
155 second-torsion-spring-receiver 155
157 crimp 157
159 connector-screw 159
160 washer 160
161 screw-hole 161
165 central hole 165
201 torsion spring 201
203 attachment-region 203
301 lighting module 301
501 recessed lighting fixture 501
503 downward facing flange 503
505 lighting-module-hole 505
550a protruding-tab-separation-gap 550a
550b protruding-tab-separation-gap 550b
600 method of using bracket ring 600
601 collapsing bracket ring 601
603 inserting bracket ring 603
605 expanding bracket ring 605
607 crimping first crimp 607
609 securing upwards-protruding tabs 609
611 tightening brackets 611
613 crimping second crimp 613
615 installing bracket ring 615
617 passing lighting module 617
619 securing torsion springs 619
621 finish pushing lighting module 621
625 installing lighting module 625
631 turning off power 631
633 removing existing lighting module 633
635 inspecting 635
637 optionally installing new connectors 637
639 preparation steps 639

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

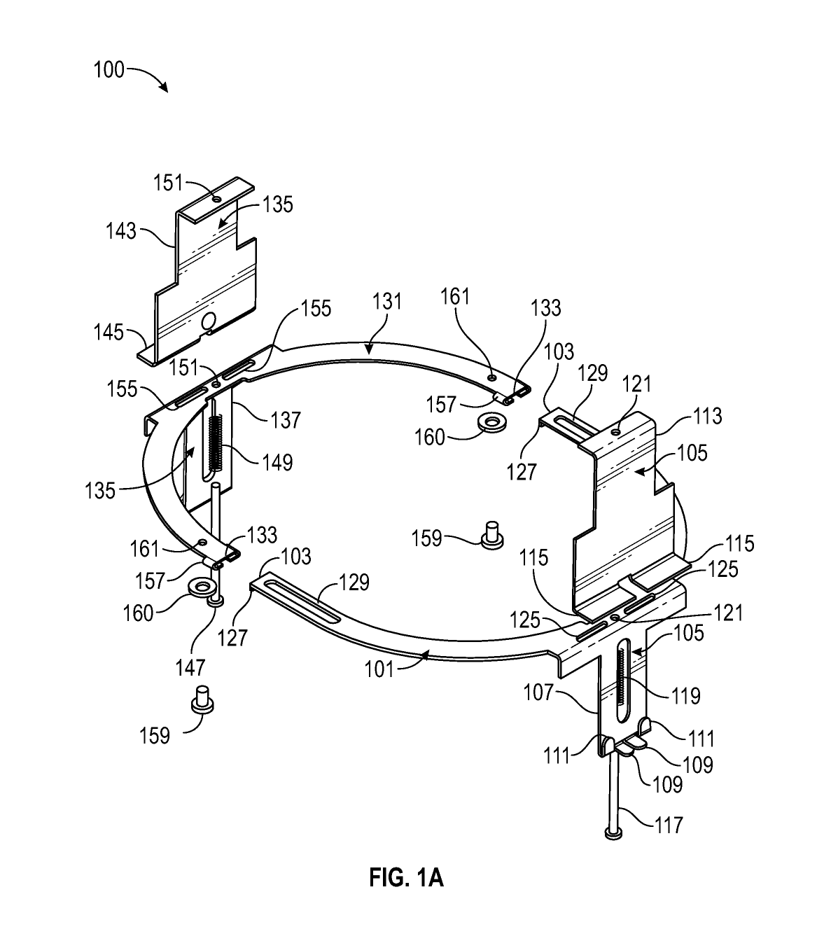

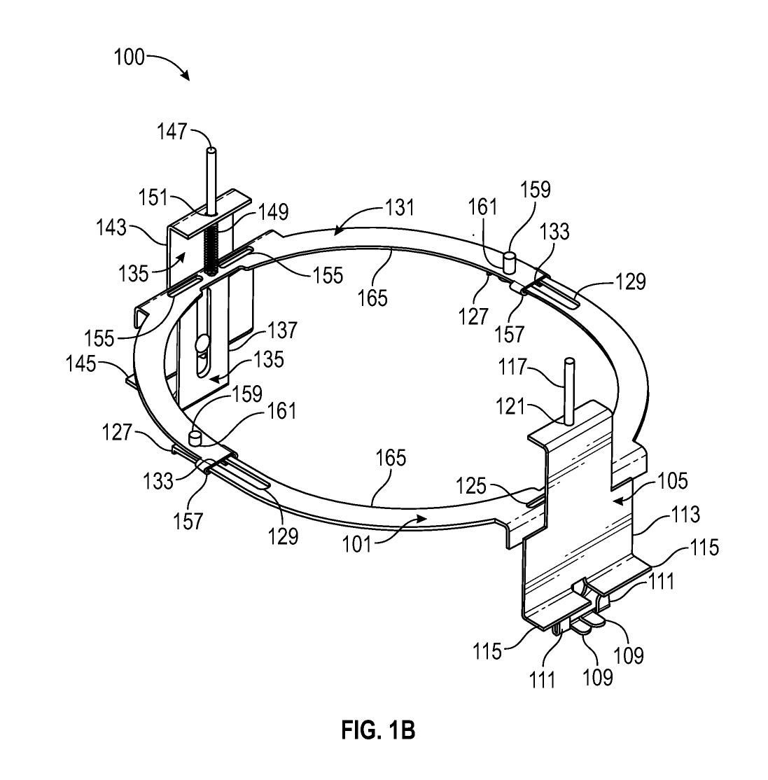

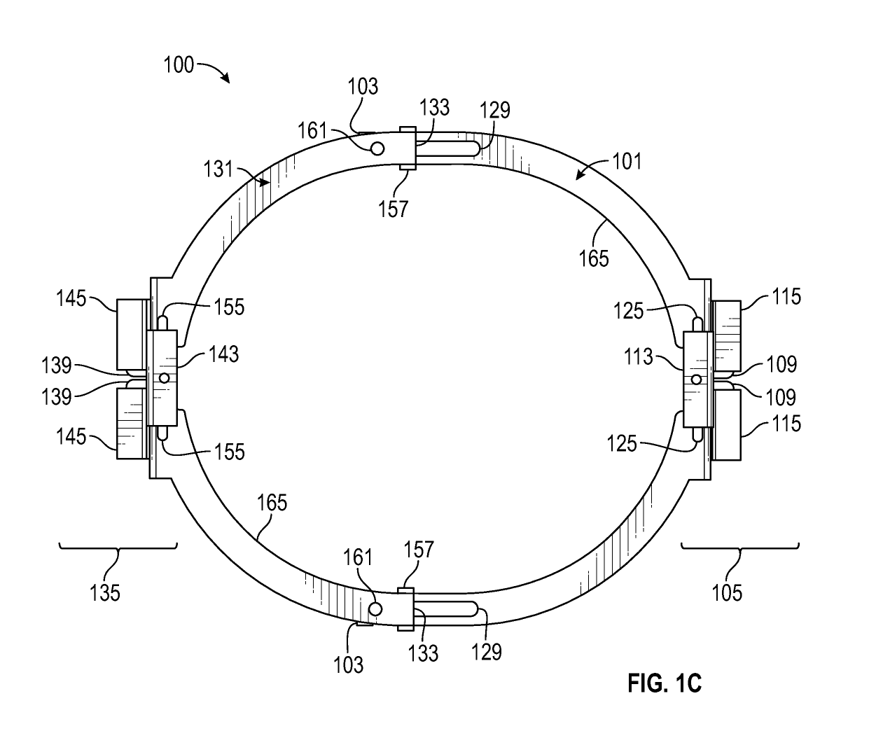

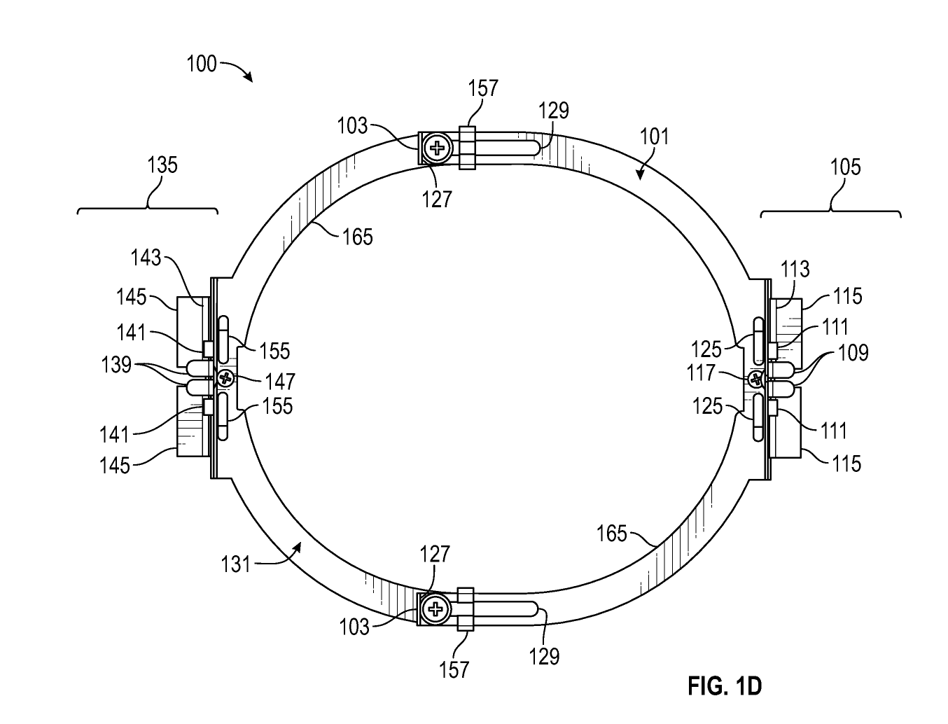

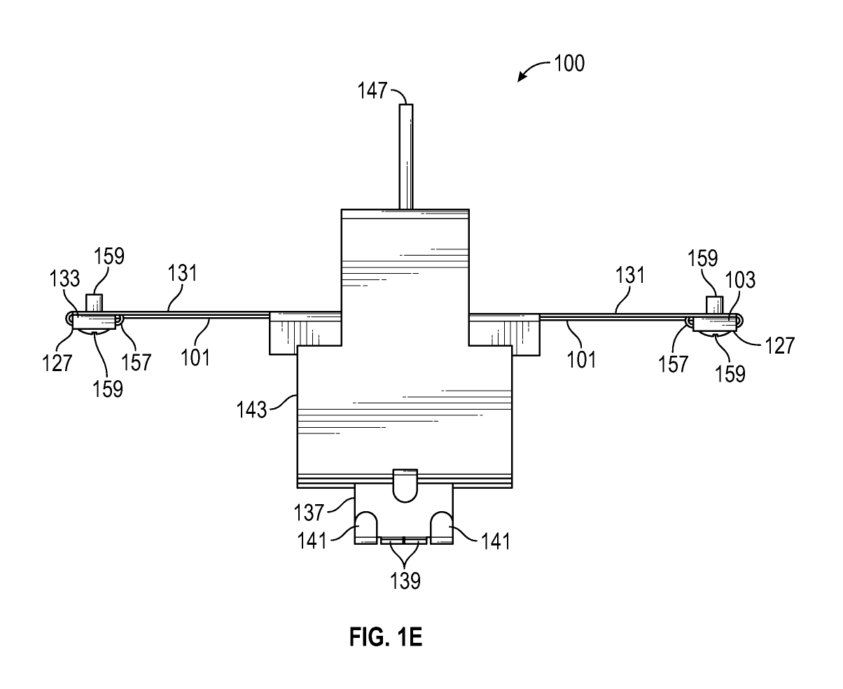

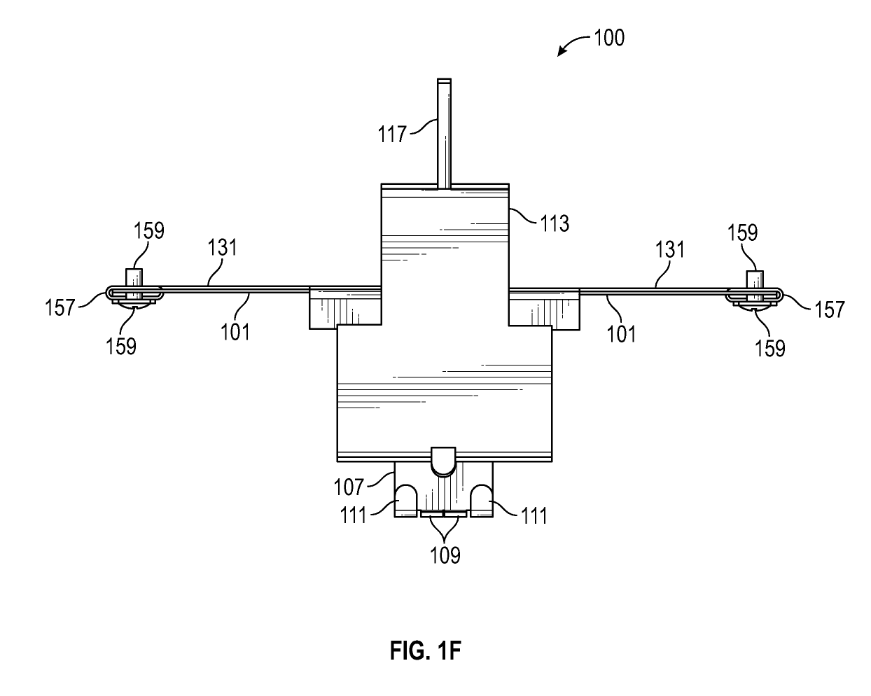

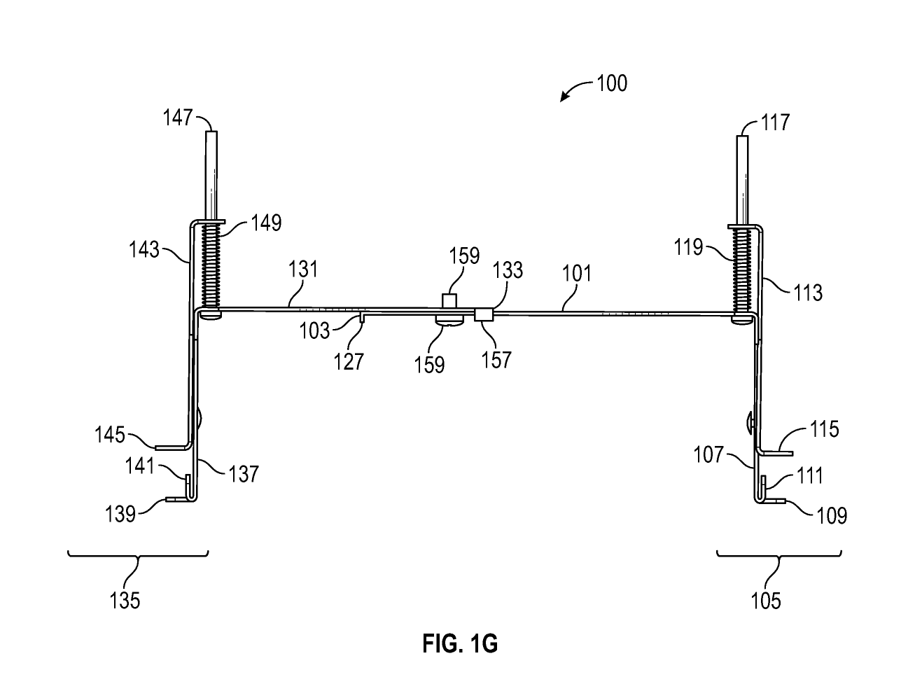

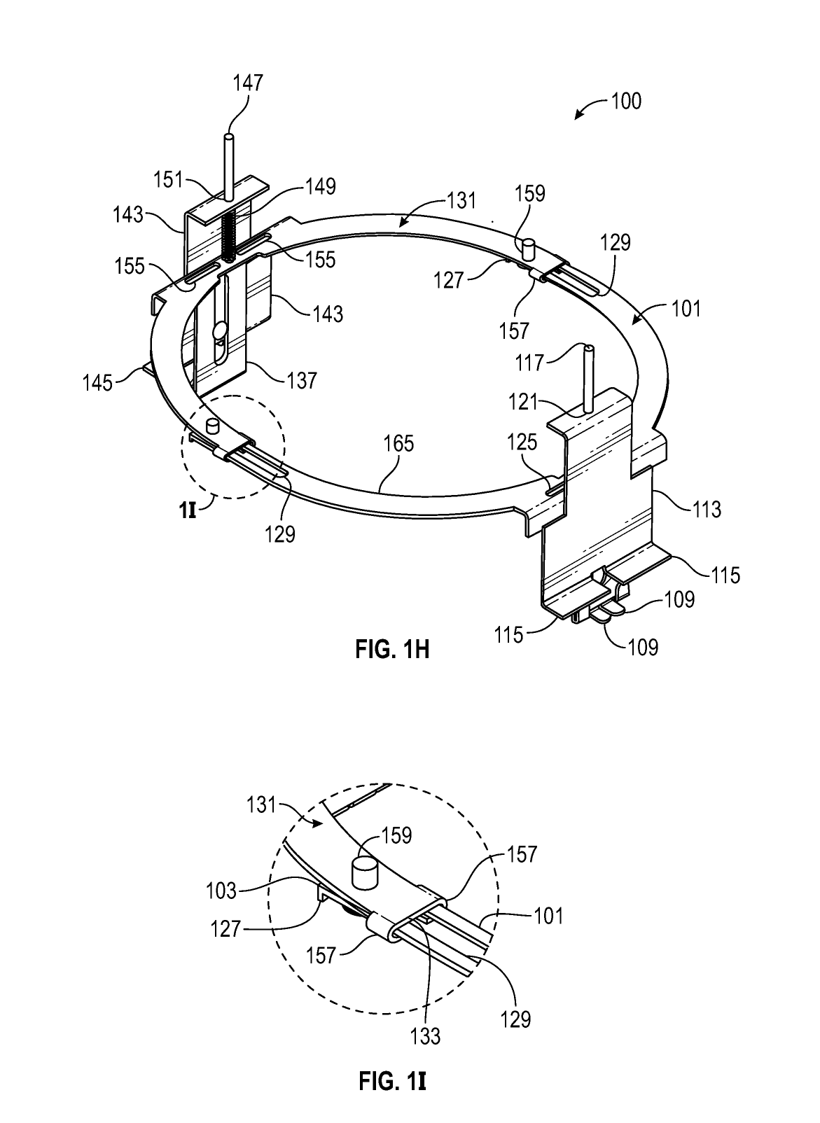

FIG. 1A may depict an exploded top perspective view of a bracket ring 100. FIG. 1B through FIG. 1I may show bracket ring 100 in an assembled configuration. FIG. 1B may depict bracket ring 100 from a top perspective view. FIG. 1C may depict bracket ring 100 from a top view. FIG. 1D may depict bracket ring 100 from a bottom view. FIG. 1E may depict bracket ring 100 from a back (rear) view. FIG. 1F may depict bracket ring 100 from a front view. FIG. 1G may depict bracket ring 100 from a side view (may be left or right as such views are substantially equivalent). FIG. 1H may depict bracket ring 100 from another top perspective view. FIG. 1H may depict detail region H. FIG. 1I may be a close up of detail region 1I from FIG. 1H.

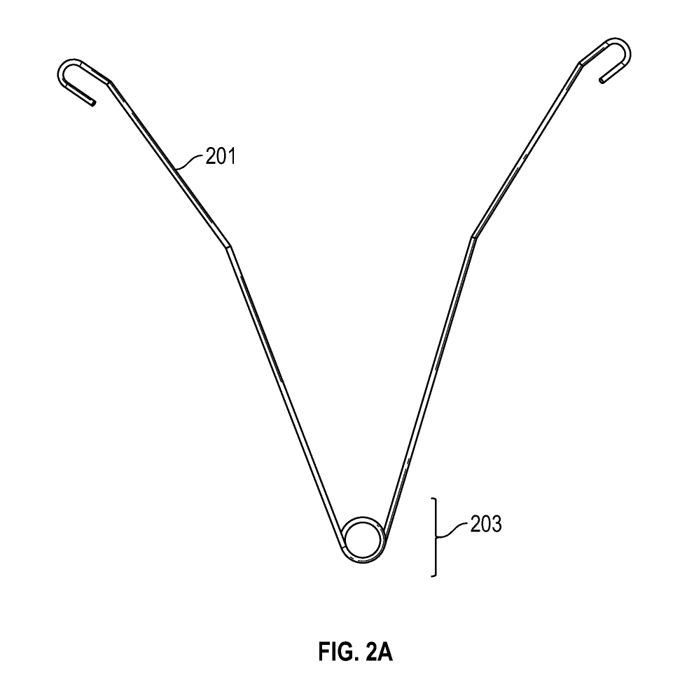

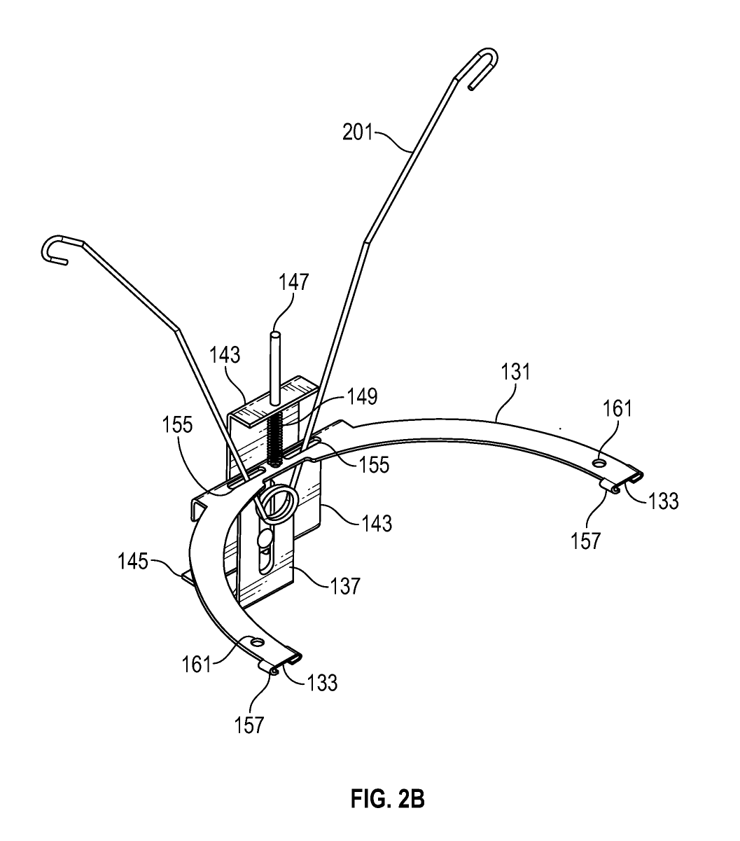

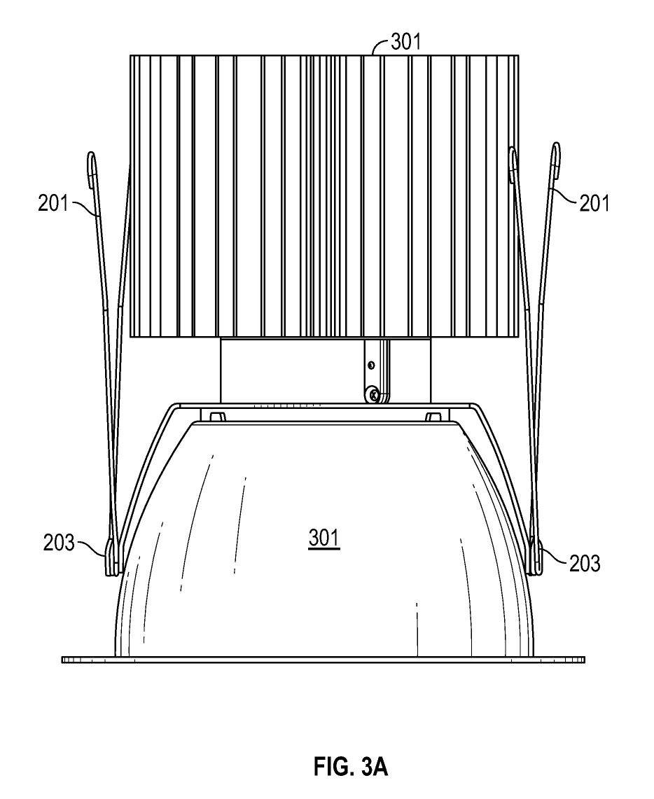

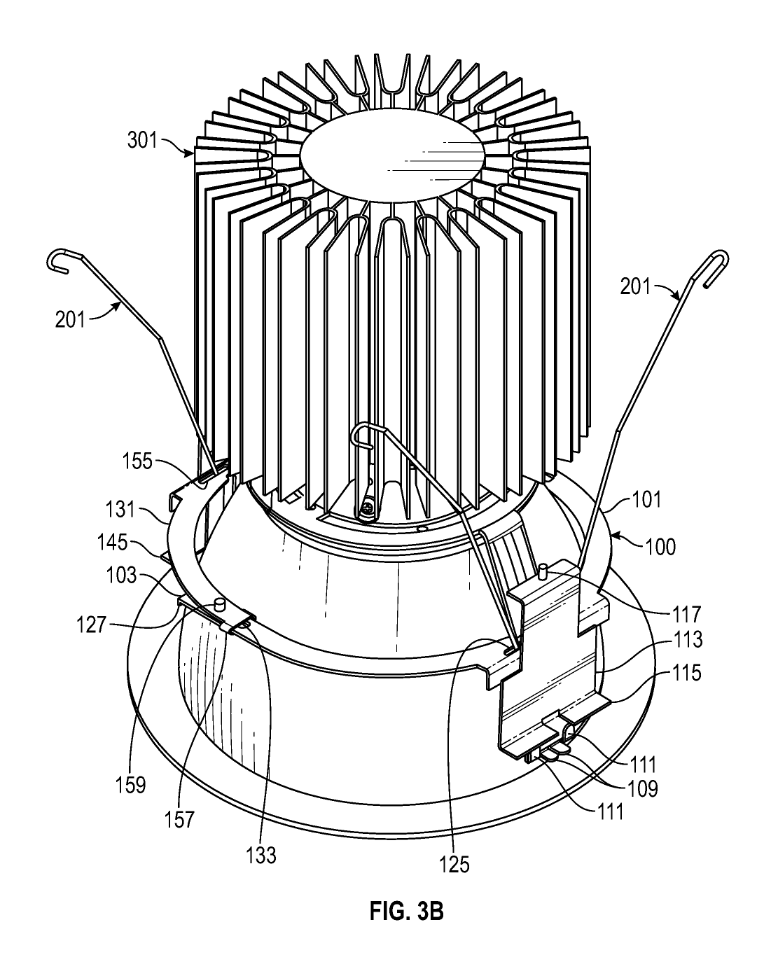

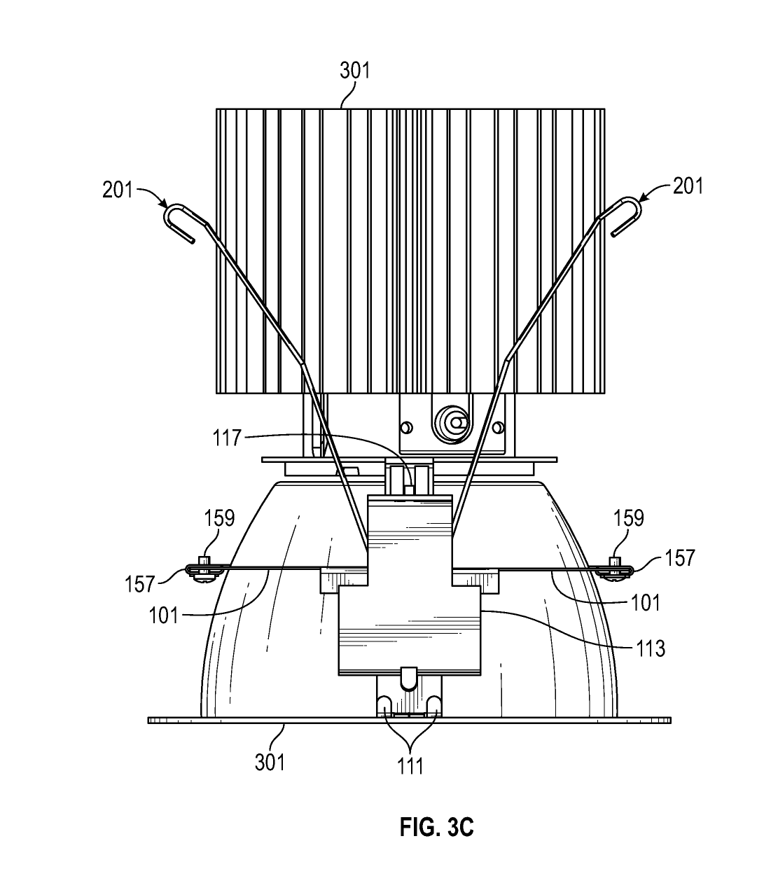

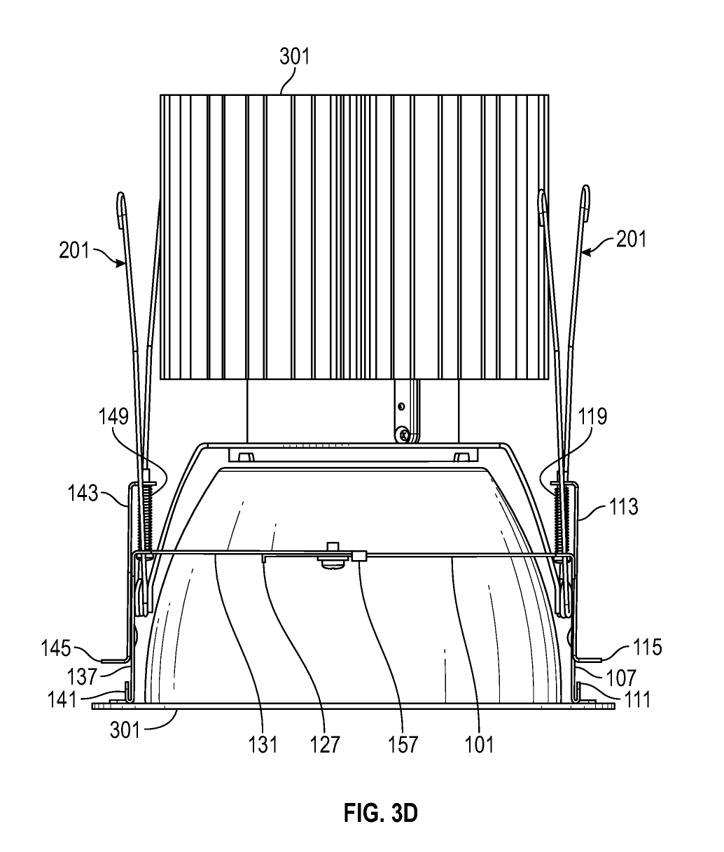

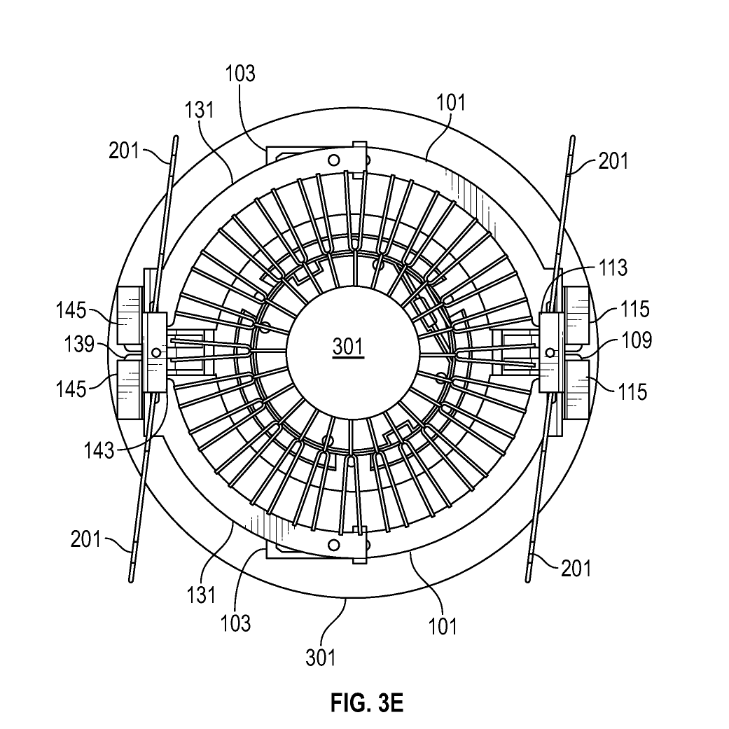

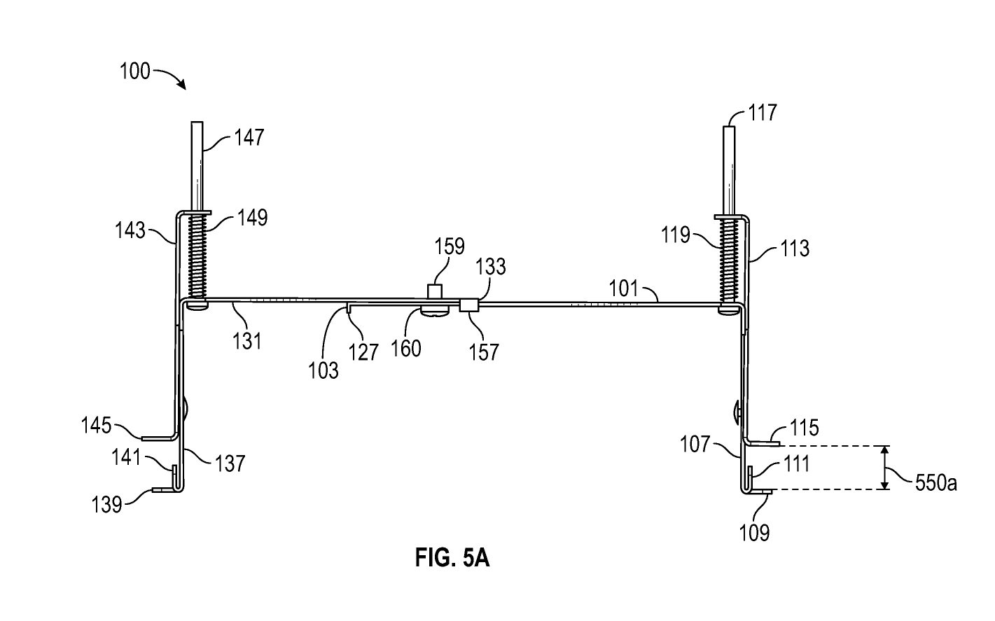

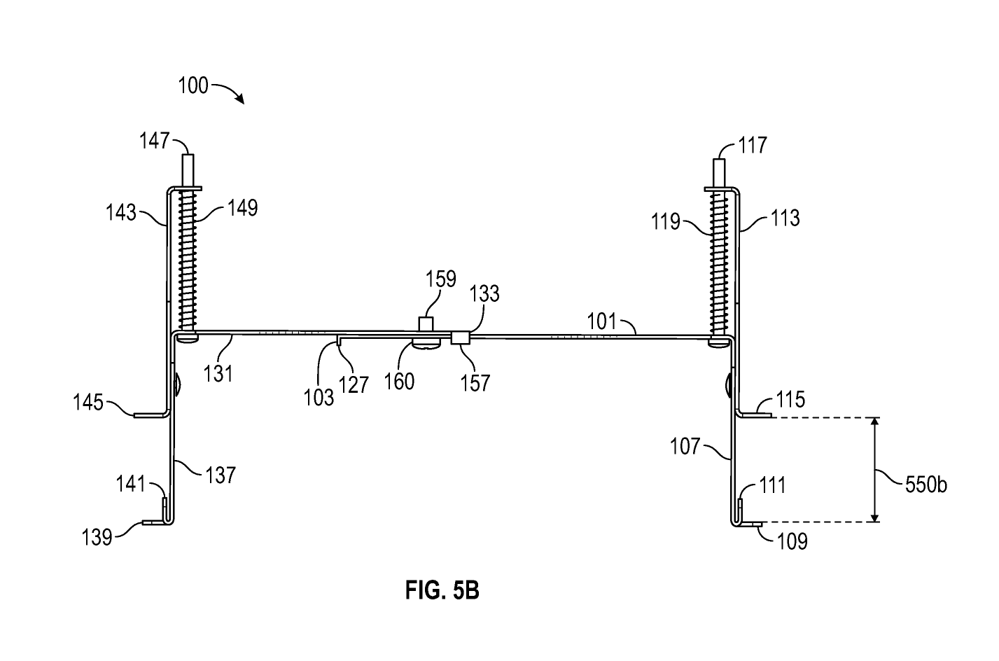

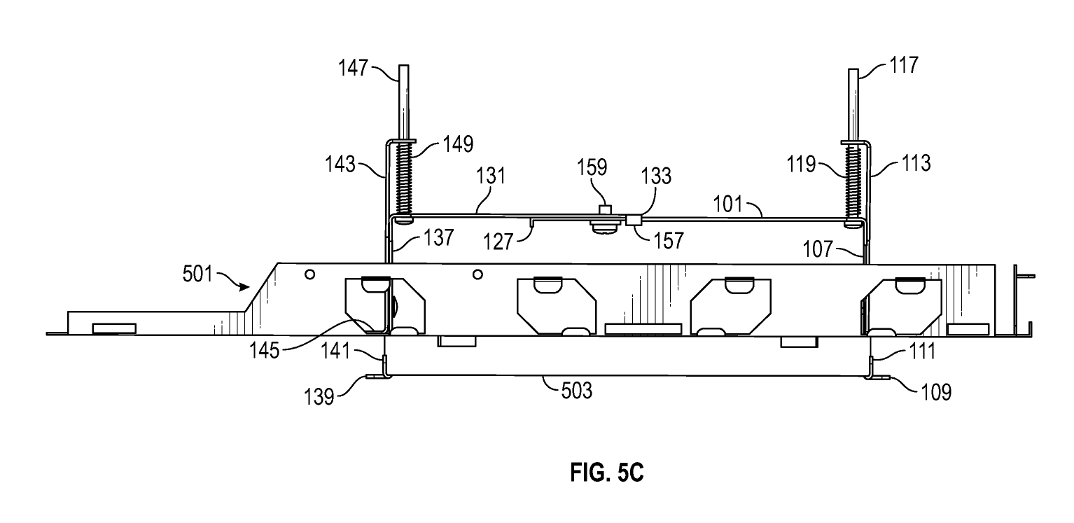

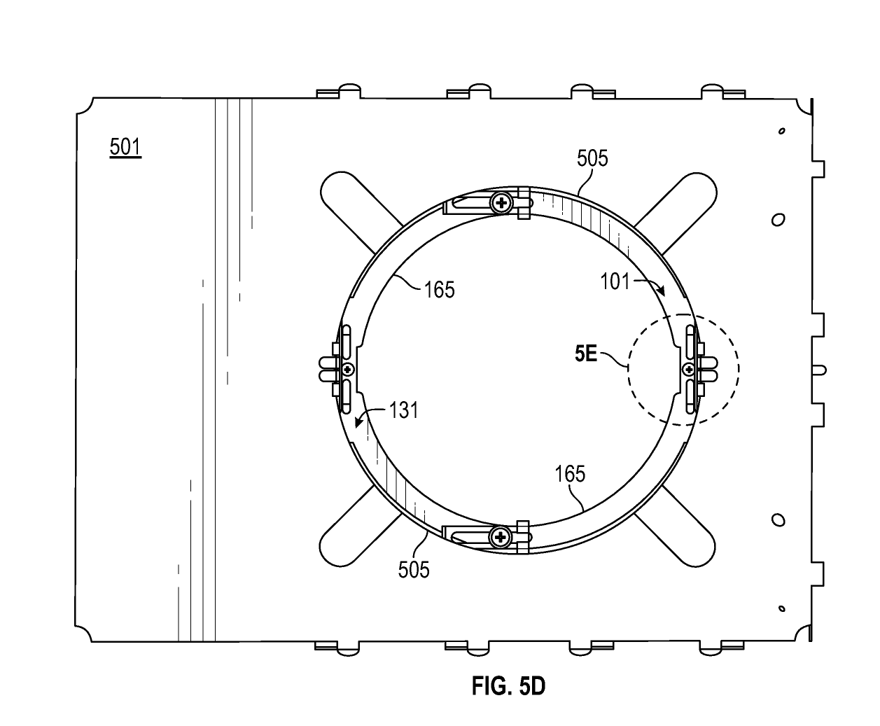

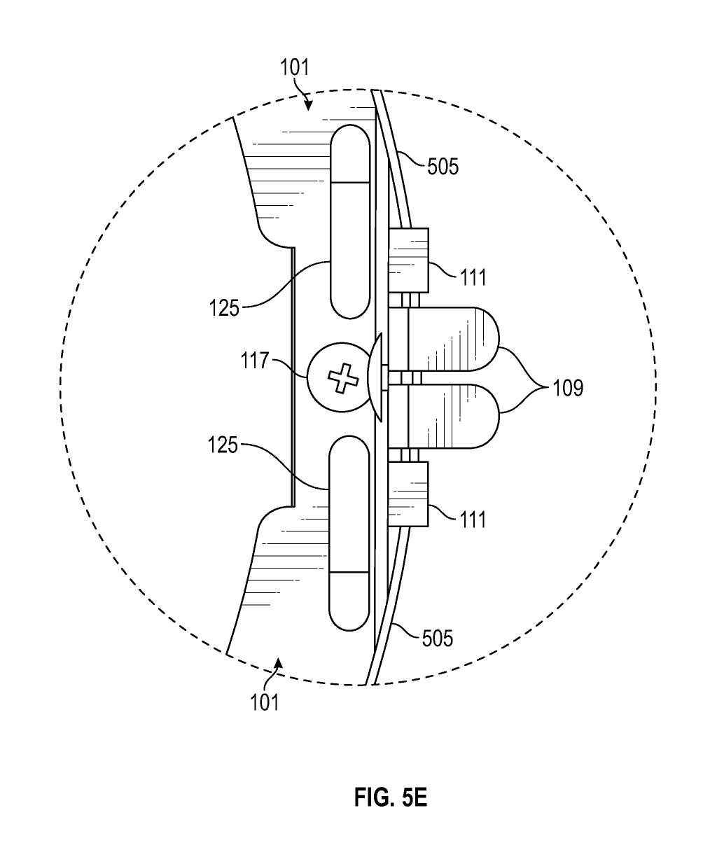

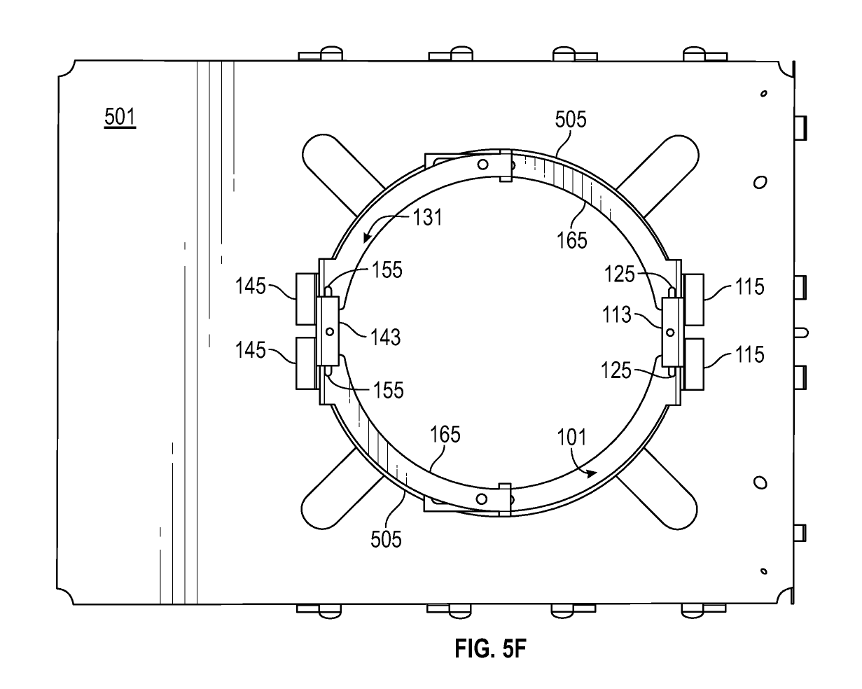

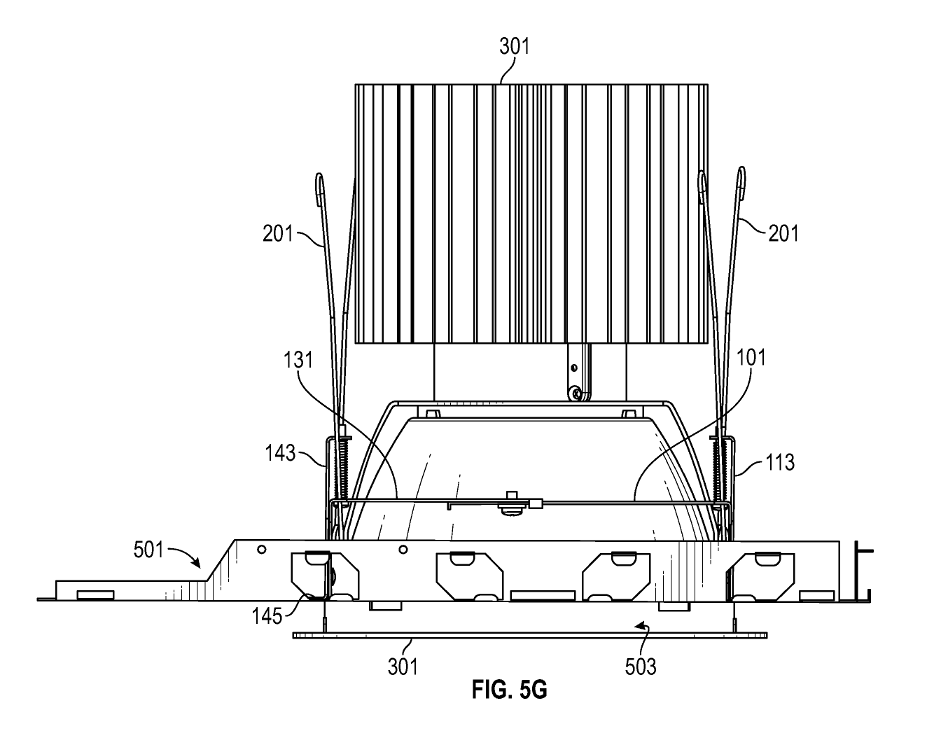

In some embodiments, bracket ring 100 may be for removably coupling to a recessed lighting fixture 501 and for providing an anchor to receive a lighting module 301 with torsion springs 201. Existing installed recessed lighting fixtures 501 may not include such an anchor location to receive torsion springs 201 attached to a given lighting module 301. Such anchor locations for torsion springs 201 are commonly known as “C-clips” within the lighting industry. In some embodiments, bracket ring 100 permits such existing installed recessed lighting fixtures 501 without the torsion spring anchor locations (e.g., C-clips) to be effectively, easily, and quickly retrofitted to accommodate lighting modules 301 with torsion springs 201. In some embodiments, bracket ring 100 may be removably attached to the given recessed lighting fixture 501; and then bracket ring 100 may removably receive a lighting module 301 with torsion springs 201. See e.g., FIG. 5C through FIG. 5G for an example of recessed lighting fixture 501, FIG. 3A for lighting module 301, and see FIG. 2B for torsion spring 201.

Discussing FIG. 1A, in some embodiments, bracket ring 100 may comprise a first-structural-curved-member 101 and a second-structural-curved-member 131. In some embodiments, in an assembled bracket ring 100, first-structural-curved-member 101 may be attached to second-structural-curved-member 131. See e.g., FIG. 1B through FIG. 1H. In some embodiments, when first-structural-curved-member 101 may be attached to second-structural-curved-member 131, a central hole 165 may be formed. See e.g., FIG. 1B, FIG. 1C, FIG. 1D, and FIG. 1H. In some embodiments, a nature of attachment (coupling) between first-structural-curved-member 101 and second-structural-curved-member 131 may be removable.

Turning back to discussing FIG. 1A, in some embodiments, first-structural-curved-member 101 may be a structural member. In some embodiments, first-structural-curved-member 101 may be rigid to semi-rigid. In some embodiments, first-structural-curved-member 101 may be curved or have curved portions. In some embodiments, first-structural-curved-member 101 may terminate in a pair of terminal ends 103. In some embodiments, first-structural-curved-member 101 may comprise a first-descending-bracket 105. In some embodiments, first-descending-bracket 105 may be configured to removably attach to a portion of recessed lighting fixture 501. In some embodiments, first-structural-curved-member 101 may comprise a first-torsion-spring-receiver 125. In some embodiments, first-torsion-spring-receiver 125 may be sized and shaped to removably receive portions of a torsion spring 201. In some embodiments, first-torsion-spring-receiver 125 may function as a “C-clip.” In some embodiments, first-torsion-spring-receiver 125 may be a “C-clip.” In some embodiments, first-torsion-spring-receiver 125 may be a slot for receiving ends of a torsion spring 201. In some embodiments, first-torsion-spring-receiver 125 may be a pair of slots; wherein each such slot may be for receiving an end of a torsion spring 201. In some embodiments, such slots for first-torsion-spring-receiver 125 may be arranged in a linear fashion. In some embodiments, a screw hole 121 may be disposed between slots of first-torsion-spring-receiver 125. In some embodiments, first-torsion-spring-receiver 125 and first-structural-curved-member 101 may be integral with each other and a single article of manufacture. See e.g., FIG. 5C and FIG. 5D for recessed lighting fixture 501 and see FIG. 2B for torsion spring 201.

Turning back to discussing FIG. 1A, in some embodiments, second-structural-curved-member 131 may be a structural member. In some embodiments, second-structural-curved-member 131 may be rigid to semi-rigid. In some embodiments, second-structural-curved-member 131 may be curved or have curved portions. In some embodiments, second-structural-curved-member 131 may terminate in a pair of different terminal ends 133. In some embodiments, second-structural-curved-member 131 may comprise a second-descending-bracket 135. In some embodiments, second-descending-bracket 135 may be configured to removably attach to some portion of recessed lighting fixture 501. In some embodiments, first-descending-bracket 105 and second-descending-bracket 135 may be removably coupled to different regions of recessed lighting fixture 501. In some embodiments, second-structural-curved-member 131 may comprise a second-torsion-spring-receiver 155. In some embodiments, second-torsion-spring-receiver 155 may be sized and shaped to removably receive portions of a torsion spring 201. In some embodiments, second-torsion-spring-receiver 155 may function as a “C-clip.” In some embodiments, second-torsion-spring-receiver 155 may be a “C-clip.” In some embodiments, second-torsion-spring-receiver 155 may be a slot for receiving ends of a torsion spring 201. In some embodiments, second-torsion-spring-receiver 155 may be a pair of slots; wherein each such slot may be for receiving an end of a torsion spring 201. In some embodiments, such slots for second-torsion-spring-receiver 155 may be arranged in a linear fashion. In some embodiments, a screw hole 151 may be disposed between slots of second-torsion-spring-receiver 155. In some embodiments, second-torsion-spring-receiver 155 and second-structural-curved-member 131 may be integral with each other and a single article of manufacture. See e.g., FIG. 5C and FIG. 5D for recessed lighting fixture 501 and see FIG. 2B for torsion spring 201.

Continuing discussing FIG. 1A, FIG. 1B, and FIG. 1H, in some embodiments, first-structural-curved-member 101 and/or second-structural-curved-member 131 may be substantially flat; not including first-descending-bracket 105, tabs 127, at least one slot 129, second-descending-bracket 135, crimps 157, and at least one slot 161. In some embodiments, first-structural-curved-member 101 and/or second-structural-curved-member 131 may be substantially planar; not including first-descending-bracket 105, tabs 127, at least one slot 129, second-descending-bracket 135, crimps 157, and at least one slot 161.

Continuing discussing FIG. 1A, FIG. 1B, and FIG. 1H, in some embodiments, first-structural-curved-member 101 and/or second-structural-curved-member 131 may each be shaped substantially as: a letter “C,” a horseshoe, a letter “U,” a semi-circle, a semi-ellipse, and/or the like. In some embodiments, central hole 165 may be substantially shaped as: a circle, an ellipse, an oval, a number “0,” a letter “0,” and/or the like. See e.g., FIG. 1B and FIG. 1H.

Continuing discussing FIG. 1A, FIG. 1B, and FIG. 1H, in some embodiments, pair of terminal ends 103 of first-structural-curved-member 101 may each extend upwards in a tab 127. In some embodiments, pair of another terminal ends 133 of second-structural-curved-member 131 may each comprise a crimp 157. In some embodiments, when first-structural-curved-member 101 and second-structural-curved member 131 may be slidingly coupled to each other, tabs 127 butting against crimps 157 may prevent first-structural-curved-member 101 from becoming decoupled from second-structural-curved-member 131. In some embodiments, crimps 157 may form receiving channels for receiving portions of first-structural-curved-member 101. In some embodiments, when crimps 157 are not crimped tight, these receiving channels may permit sliding translation between portions of first-structural-curved-member 101 and second-structural-curved-member 131.

Discussing FIG. 1H and FIG. 1I, in some embodiments, when first-structural-curved-member 101 and second-structural-curved member 131 may be slidingly coupled to each other; tightening of crimps 157 against portions of first-structural-curved-member 101 may prevents further sliding translation between first-structural-curved-member 101 and second-structural-curved member 131. In some embodiments, tightening of crimps 157 against portions of first-structural-curved-member 101 may fix first-structural-curved-member 101 to second-structural-curved-member 131. In some embodiments, crimps 157 may be strong enough to require aid of a mechanical advantage to tighten crimps 157, such as use of pliers.

Discussing FIG. 1H and FIG. 1I, in some embodiments, at least one slot 161 may be screw-hole 161. In some embodiments, screw-holes 161 may be sized to receive threaded portions of connector-screws 159. When each end (e.g., terminal end 103) of first-structural-curved-member 101 may be slidingly coupled to each respective end (e.g., different terminal ends 133) of second-structural-curved-member 131 (e.g., as shown in FIG. 1B by interactions of tabs 127 and crimps 157), the two respective at least one slots 129 of first-structural-curved-member 101 may overlap with the two screw-holes 161 of second-structural-curved-member 131, and a connector-screw 159 may then secure second-structural-curved-member 131 to first-structural-curved-member 101 by a thread portion threading through a respective screw-hole 161 and then through a respective at least one slot 121. In some embodiments, a washer 160 may also be used with each connector-screw 159. In some embodiments, on a given second-structural-curved-member 131, a crimp 157 may be disposed between different terminal ends 133 and a screw-hole 161. In some embodiments, on a given second-structural-curved-member 131, screw-hole may be located a predetermined distance from different terminal ends 133; wherein in some embodiments, this predetermined distance may be three inches or less. In some embodiments, on a given second-structural-curved-member 131, screw-hole may be located a predetermined distance from different terminal ends 133; wherein in some embodiments, this predetermined distance may be from three inches to one eighth of an inch. In some embodiments, once first-structural-curved-member 101 may be slidingly coupled to second-structural-curved-member 131, connector-screws 159 may be attached as noted above and tightened in order to fix a size for central hole 165.

Continuing discussing FIG. 1A, FIG. 1B, and FIG. 1H, in some embodiments, first-structural-curved-member 101 may comprise at least one slot 129 in a curved portion of first-structural-curved-member 101. In some embodiments, second-structural-curved-member 131 may comprise at least one slot 161 in a curved portion of second-structural-curved-member 131. In some embodiments, at least one slot 129 of first-structural-curved-member 101 may be first-torsion-spring-receiver 125. In some embodiments, at least one slot 161 of second-structural-curved-member 131 may be second-torsion-spring-receiver 155.

Continuing discussing FIG. 1A, FIG. 1B, and FIG. 1H, in some embodiments, first-torsion-spring-receiver 125 be selected from: a slot or a C-clip. In some embodiments, second-torsion-spring-receiver 155 be selected from: a different slot or a different C-clip. Such slots, different slots, C-clips and/or different C-clips may be sized and shaped to removably receive portions of torsion springs 201.

Continuing discussing FIG. 1A, FIG. 1B, and FIG. 1H, in some embodiments, when first-structural-curved-member 101 and second-structural-curved member 131 may be slidingly coupled to each other, first-torsion-spring-receiver 125 and second-torsion-spring-receiver 155 may be substantially opposed from each other.

Continuing discussing FIG. 1A, FIG. 1B, and FIG. 1H, in some embodiments, when first-structural-curved-member 101 and second-structural-curved member 131 may be slidingly coupled to each other, first-descending-bracket 105 and second-descending-bracket 135 may be substantially opposed from each other.

Continuing discussing FIG. 1A, FIG. 1B, and FIG. 1H, and discussing, FIG. 1E, FIG. 1F, and FIG. 1G, in some embodiments, when first-structural-curved-member 101 and second-structural-curved member 131 may be slidingly coupled to each other, forming central hole 165, curved portions of first-structural-curved-member 101 and curved portions of second-structural-curved member 131, and central hole 165, may all substantially share a common plane. In some embodiments, when first-structural-curved-member 101 and second-structural-curved member 131 may be slidingly coupled to each other, forming central hole 165, a majority of first-structural-curved-member 101 and a majority of second-structural-curved member 131, and central hole 165, may all substantially share the common plane. In some embodiments, when first-structural-curved-member 101 and second-structural-curved member 131 may be slidingly coupled to each other, forming central hole 165, curved portions of first-structural-curved-member 101 and curved portions of second-structural-curved member 131, and central hole 165, may all shares planes which are substantially parallel to each other. In some embodiments, when first-structural-curved-member 101 and second-structural-curved member 131 may be slidingly coupled to each other, forming central hole 165, a majority of first-structural-curved-member 101 and a majority of second-structural-curved member 131, and central hole 165, may all shares planes which are substantially parallel to each other. See e.g., FIG. 1E, FIG. 1F, and FIG. 1G.

Continuing discussing FIG. 1A, FIG. 1B, FIG. 1E, FIG. 1F, FIG. 1G, and FIG. 1H, in some embodiments, first-descending-bracket 105 and second-descending-bracket 135 may both descend substantially perpendicularly away from the common plane (of the substantially parallel planes). See e.g., FIG. 1G. In some embodiments, first-descending-bracket 105 and second-descending-bracket 135 may each be located substantially midway or halfway (from a top view) on their respective structural-curved-members (101 and 131, respectively). See e.g., FIG. 1A, FIG. 1B, and FIG. 1C.

Continuing discussing FIG. 1A, FIG. 1B, FIG. 1G, and FIG. 1H, in some embodiments, both first-descending-bracket and second-descending-bracket may each operate as a separate clamp to clamp onto a ledge or some structure of recessed lighting fixture 501. See also FIG. 5A, FIG. 5B, and FIG. 5C.

Continuing discussing FIG. 1A, FIG. 1B, FIG. 1G, and FIG. 1H, in some embodiments, first-descending-bracket 105 may comprise: a fixed-bracket 107 and a slidable-bracket 113. In some embodiments, fixed-bracket 107 may have protruding tabs 109. In some embodiments, protruding tabs 109 may extend in a direction that is substantially parallel with the common plane, but not in the common plane. In some embodiments, protruding tabs 109 may protrude substantially orthogonally away from a major longitude of fixed-bracket 107. In some embodiments, fixed-bracket 107 may have upwards-protruding-tabs 111 that may extend upwards from a bottom of fixed-bracket 107. In some embodiments, fixed-bracket 107 may be fixed to first-structural-curved-member 101. In some embodiments, fixed-bracket 107 may be fixed to first-structural-curved-member 101 at a top of fixed-bracket 107. In some embodiments, fixed-bracket 107 may be integral to first-structural-curved-member 101; such that fixed bracket 107 and first-structural-curved-member 101 may be a single article of manufacture. In some embodiments, slidable-bracket 113 may have different protruding tabs 115. In some embodiments, different protruding tabs 115 may extend in a direction that is substantially parallel with the common plane. In some embodiments, different protruding tabs 115 may protrude substantially orthogonally away from a major longitude of slidable-bracket 113. In some embodiments, slidable-bracket 113 may be slidingly coupled to fixed-bracket 107. In some embodiments, slidable-bracket 113 may be slidingly coupled to fixed-bracket 107 via screw 117.

Continuing discussing FIG. 1A, FIG. 1B, FIG. 1G, and FIG. 1H, in some embodiments, first-descending-bracket 105 may comprise screw 117 and a spring 119 for adjustment of clamp mechanics of first-descending-bracket 105. In some embodiments screw 117 and spring 119 may be substantially concentric and collinear with each other, with portions of a length of screw 117 passing through a hollow core of spring 119. In some embodiments, screw 117 may be coupled to both fixed-bracket 107 and to slidable-bracket 113. In some embodiments, coupling of fixed-bracket 107 to slidable-bracket 113 via screw 117 may be accomplished with screw holes 121.

Continuing discussing FIG. 1A, FIG. 1B, FIG. 1G, and FIG. 1H, in some embodiments, second-descending-bracket 135 may comprise: a fixed-bracket 137 and a slidable-bracket 143. In some embodiments, fixed-bracket 137 may have protruding tabs 139. In some embodiments, protruding tabs 139 may extend in a direction that is substantially parallel with the common plane, but not in the common plane. In some embodiments, protruding tabs 139 may protrude substantially orthogonally away from a major longitude of fixed-bracket 137. In some embodiments, fixed-bracket 137 may have upwards-protruding-tabs 141 that may extend upwards from a bottom of fixed-bracket 137. In some embodiments, fixed-bracket 137 may be fixed to second-structural-curved-member 131. In some embodiments, fixed-bracket 137 may be fixed to second-structural-curved-member 131 at a top of fixed-bracket 137. In some embodiments, fixed-bracket 137 may be integral to second-structural-curved-member 131; such that fixed bracket 137 and second-structural-curved-member 131 may be a single article of manufacture. In some embodiments, slidable-bracket 143 may have different protruding tabs 145. In some embodiments, different protruding tabs 145 may extend in a direction that is substantially parallel with the common plane. In some embodiments, different protruding tabs 145 may protrude substantially orthogonally away from a major longitude of slidable-bracket 143. In some embodiments, slidable-bracket 143 may be slidingly coupled to fixed-bracket 137. In some embodiments, slidable-bracket 143 may be slidingly coupled to fixed-bracket 137 via screw 147.

Continuing discussing FIG. 1A, FIG. 1B, FIG. 1G, and FIG. 1H, in some embodiments, second-descending-bracket 135 may comprise screw 147 and a spring 149 for adjustment of clamp mechanics of second-descending-bracket 135. In some embodiments screw 147 and spring 149 may be substantially concentric and collinear with each other, with portions of a length of screw 147 passing through a hollow core of spring 149. In some embodiments, screw 147 may be coupled to both fixed-bracket 137 and to slidable-bracket 143. In some embodiments, coupling of fixed-bracket 137 to slidable-bracket 143 via screw 147 may be accomplished with screw holes 151.

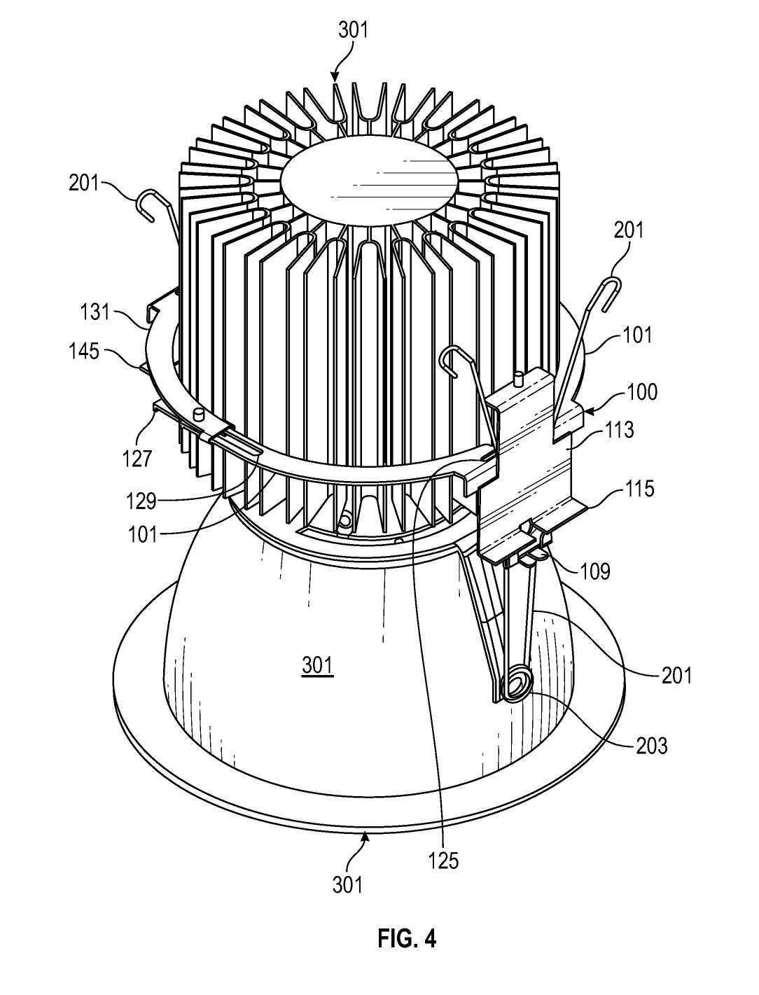

Discussing FIG. 1B and FIG. 1H, in some embodiments, first-structural-curved-member 101 and second-structural-curved-member 131 may be slidingly coupled to each other. In some embodiments, this slidingly coupling may be accomplished by pair of terminal ends 103 overlapping with pair of different terminal ends 133; such that portions of first-structural-curved-member 101, in a region of overlap, may be on top of portions of second-structural-curved-member 131. In some embodiments, when first-structural-curved-member 101 and second-structural-curved-member 131 may be slidingly coupled to each other central hole 165 may be formed. In some embodiments, this central hole 165 may be sized and shaped to accommodate a portion of lighting module 301. See e.g., FIG. 3A and FIG. 4 to see portions of lighting module 301 inserted through central hole 165.

Discussing FIG. 1A, FIG. 1B, FIG. 1C, FIG. 1D, FIG. 1E, and FIG. 1F, in some embodiments, first-torsion-spring-receiver 125 and second-torsion-spring-receiver 155 may each be located substantially midway or halfway (from a top view or a bottom view or front view or a back view) on their respective structural-curved-members (101 and 131, respectively).

In some embodiments, clamp mechanics, i.e., clamp tightening and/or loosening of the brackets (e.g., 105 and 135), may be provided by ratchet mechanics, known in the art, instead of using the screws (e.g., 117 and 147) and springs (e.g., 119 and 149).

In some embodiments, sliding coupling of the structural-curved-members (e.g., 101 and 131) to each other, may be provided by ratchet mechanics, known in the art, instead of using crimps 157.

In some embodiments, components of bracket ring 100, as noted above, may be substantially constructed from rigid to semi-rigid materials of construction. Such materials of construction may be selected from metals and/or plastics. For example, and without limiting the disclosure in the present invention, some such metals may be aluminum, steel, and/or stainless steel.

FIG. 2A may depict a front view of a torsion spring 201. In some embodiments, a given torsion spring 201 may comprise a torsion spring located in a center region disposed between arms. Such torsion springs 201 may be commonly attached to lighting modules 301, in order to aid efficient lighting module 301 installation (see e.g., FIG. 3A). In some embodiments, a given torsion spring 201 may comprise attachment-region 203. In some embodiments, attachment-region 203 may be a region of torsion spring 201 where the given torsion spring torsion spring 201 may be attached to a given lighting module 301, see e.g., FIG. 3A.

FIG. 2B may depict a torsion spring 201 removably attached to second-torsion-spring-receiver 155 of structural-curved-member 131 of bracket ring 100, shown from a top perspective view. This torsion spring 201 interaction with second-torsion-spring-receiver 155 may also be how a given torsion spring 201 interacts with first-torsion-spring-receiver 125. This torsion spring 201 interaction with torsion-spring-receivers (e.g., 155 and/or 125) may be the same type of torsion spring 201 interaction with torsion-spring-receivers (e.g., 155 and/or 125) shown in FIG. 3A, FIG. 3B, FIG. 3C, and FIG. 3D.

FIG. 3A may depict a lighting module 301 with the torsion springs 201, shown from a side view. Lighting module 301 may have two opposing pairs of torsion springs 201 attached to lighting module 301.

FIG. 3B may depict lighting module 301 with torsion springs 201 removably coupled to bracket ring 100, shown from a top perspective view. FIG. 3C may depict lighting module 301 with torsion springs 201 removably coupled to bracket ring 100 from FIG. 3B, shown from a front view. FIG. 3D may depict lighting module 301 with torsion springs 201 removably coupled to bracket ring 100 from FIG. 3B, shown from a side view. FIG. 3E may depict lighting module 301 with torsion springs 201 removably coupled to bracket ring 100 from FIG. 3B, shown from a top view. In FIG. 3B, FIG. 3C, FIG. 3D, and FIG. 3E, the shown torsion springs 201 may be fully engaged with respective torsion-spring-receivers (e.g., 125 and 155) of bracket ring 100.

Discussing FIG. 3B, in some embodiments, when some portion of lighting module 301 may be inserted into central hole 165, a pair of torsion springs 201 attached to the lighting module 301 may be removably received at first-torsion-spring-receiver 125 and at second-torsion-spring-receiver 155, respectively, resulting in lighting module 301 being anchored to the bracket ring 100 that may be removably coupled to recessed lighting fixture 501 (note, recessed lighting fixture 501 may be first depicted in FIG. 5C). See also, FIG. 3C, FIG. 3D, and FIG. 3E.

In FIG. 4, torsion springs 201 may not yet be fully engaged at respective torsion-spring-receivers (e.g., 125 and 155). That is, FIG. 4 may depict a process of lighting module 301 being inserted into central hole 165 of bracket ring 100, where the respective torsion-spring-receiver (e.g., 125 and 155) are not yet fully engaging torsion springs 201. FIG. 4 may depict lighting module 301 with torsion springs 201 in the process of being removably coupled to bracket ring 100, shown from a top perspective view.

FIG. 5A, FIG. 5B, FIG. 5C, FIG. 5D, FIG. 5E, FIG. 5F, and FIG. 5G may focus on showing how brackets (e.g., first-descending-bracket 105 and second-descending-bracket 135) of bracket ring 100 may interact and clamp recessed lighting fixture 501.

FIG. 5A may depict a side view of bracket ring 100 with brackets (e.g., 105 and 135) in one configuration showing protruding-tab-separation-gap 550a. FIG. 5B may depict a side view of bracket ring 100 with brackets (e.g., 105 and 135) in another configuration showing protruding-tab-separation-gap 550b. In FIG. 5A, protruding-tab-separation-gap 550a may be a distance between protruding tabs (e.g., 109 or 139) and different protruding tabs (e.g., 115 or 145, respectively). In FIG. 5B, protruding-tab-separation-gap 550b may be a distance between protruding tabs (e.g., 109 or 139) and different protruding tabs (e.g., 115 or 145, respectively). Note, protruding-tab-separation-gap 550b may be larger than protruding-tab-separation-gap 550a in this example comparison between FIG. 5A and FIG. 5B. FIG. 5A and FIG. 5B taken together demonstrate how these protruding-tab-separation-gaps may be varied and adjusted by the clamp mechanics of the given descending-bracket (e.g., 105 and 135). These variations and adjustments may be made in some embodiments by turning of the screws (e.g., 117 and 147).

FIG. 5C may depict a side view of bracket ring 100, with the brackets (e.g., 105 and 135) removably clamping portions of recessed lighting fixture 501. FIG. 5D may depict a bottom perspective view of bracket ring 100, with the brackets (e.g., 105 and 135) removably clamping portions of recessed lighting fixture 501. FIG. 5D may also show downward facing flange 503 of recessed lighting fixture 501. FIG. 5D may also show lighting-module-hole 505 of recessed lighting fixture 501; as well as showing central hole 165 of bracket ring 100. In some embodiments, central hole 165 may be substantially concentric with lighting-module-hole 505 in recessed lighting fixture 501. FIG. 5D may include detail region 5E. FIG. 5E may be a close up view of detail region 5E that may show how upwards-protruding tabs 111 may support and latch onto downward facing flange 503 of recessed lighting fixture 501. Upwards-protruding-tabs 141 may also be supporting and latching onto a different region of downward facing flange 503 of recessed lighting fixture 501.

Discussing FIG. 5A, FIG. 5B, and FIG. 5C, in some embodiments, protruding tabs 109 of fixed-bracket 107 and different protruding tabs 115 of the slidable-bracket 113 may clamp opposing portions of recessed lighting fixture 501. In some embodiments, protruding tabs 139 of fixed-bracket 137 and different protruding tabs 145 of the slidable-bracket 143 may clamp opposing different portions of recessed lighting fixture 501. In some embodiments, turning of screw 117 lowers or raises slidable-bracket 113 in relation to fixed-bracket 107. In some embodiments, turning of screw 147 lowers or raises slidable-bracket 143 in relation to fixed-bracket 137. Such screw (e.g., 117 and/or 147) turning then tightens or loosens these respective brackets against structures of recessed lighting fixture 501.

Discussing FIG. 5D and FIG. 5E, in some embodiments, upwards-protruding-tabs 111 of fixed-bracket 107 and different protruding tabs 115 of slidable-bracket 113 may clamp different portions of recessed lighting fixture 501. In some embodiments, upwards-protruding-tabs 111 may capture portions of a downward facing flange 503 of recessed lighting fixture 501. In some embodiments, upwards-protruding-tabs 141 of fixed-bracket 137 and different protruding tabs 145 of slidable-bracket 143 may clamp different portions of recessed lighting fixture 501. In some embodiments, upwards-protruding-tabs 141 may capture different portions of a downward facing flange 503 of recessed lighting fixture 501.

FIG. 5F may depict a top view of a bracket ring (removably) installed into recessed lighting fixture 501. In FIG. 5F different protruding tabs (e.g., 115 and 145) may be butting against and clamping (squeezing) structure of recessed lighting fixture 501.

FIG. 5G may depict a side view of the bracket ring 100 of FIG. 5A, with the brackets (e.g., first-descending-bracket 105 and second-descending-bracket 135) removably clamping portions of a recessed lighting fixture 501, but in FIG. 5G a lighting module 301 with attached torsion springs 201 may also be shown. The lighting module 301 with attached torsion springs 201 may be shown in a completed installation configuration of the lighting module 301 with respect to recessed lighting fixture 501. Without attachment of bracket ring 100 to recessed lighting fixture 501 (e.g., as shown in FIG. 5C through FIG. 5G), lighting module 301 with attached torsion springs 201 would have no structure in recessed lighting fixture 501 to attach to.

Some embodiments of the invention may be systems. In some embodiments, such a system may be for mounting a lighting module 301 to a bracket ring 100. In some embodiments, such a system may comprise one or more bracket rings 100 and one or more lighting module 301 with torsion springs 201.

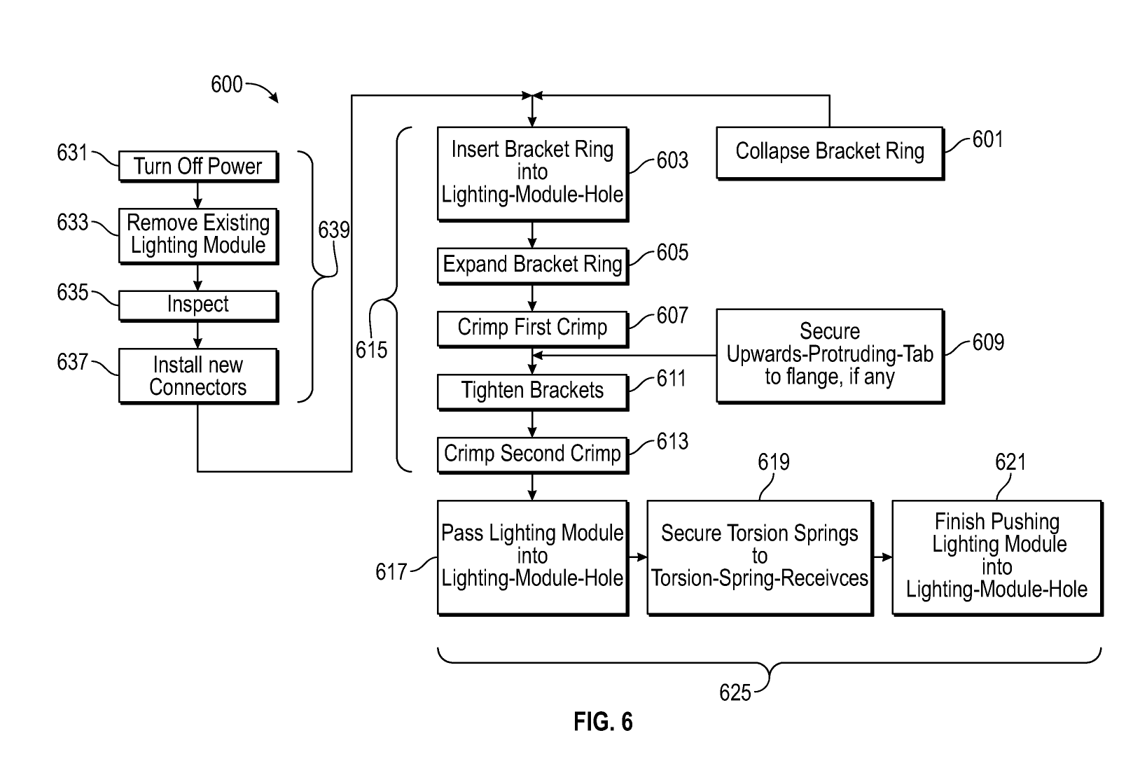

FIG. 6 may depict a flow diagram of methods 600 of using and/or installing bracket ring 100 with recessed lighting fixture 501 and/or methods 600 of using and/or installing bracket ring 100 with lighting module 301 with torsion springs 201.

Discussing FIG. 6, in some embodiments, method 600 may comprise steps 615, wherein steps 615 may be steps for installing a given bracket ring 100 to a given recessed lighting fixture 501. In some embodiments, method 600 may comprise steps 615 and steps 625. In some embodiments, steps 625 may comprise steps for installing a given lighting module 301 with torsion springs 201 to the given bracket ring 100 that may have been installed in the given recessed lighting fixture 501. In some embodiments, method 600 may comprise steps 639 and steps 615. In some embodiments, steps 639 may be steps which may proceed steps 615. In some embodiments, steps 639 may be preparation steps. In some embodiments, method 600 may comprise steps 639, followed by steps 615, and then followed by steps 625.

Continuing discussing FIG. 6, in some embodiments, steps 615 may comprise: step 603, step 605, step 607, step 611, and step 613. In some embodiments, step 603 may be a step of inserting bracket ring 100 into a lighting-module-hole 505 of recessed lighting fixture 501. In some embodiments, step 603 of inserting bracket ring 100, may be done while bracket ring 100 may in a sufficiently smallest configuration for first-structural-curved-member 101 and second-structural-curved-member 131 (while coupled to each other) to fit into the lighting-module-hole 505 of recessed lighting fixture 501. In some embodiments, step 605 may be a step of expanding bracket ring 100 to a maximum configuration permitted by a size of the lighting-module-hole 505, by expanding central hole 165 of bracket ring 100. In some embodiments, step 607 may be a step of crimping a first crimp 157, to secure one terminal end 103 of first-structural-curved-member 101 of bracket ring 100 to another terminal end 133 of second-structural-curved-member 131 of the bracket ring 100. In some embodiments, step 611 may be a step of tightening brackets (e.g., first-descending-bracket 105 and second-descending-bracket 135) of bracket ring 100 against structures of recessed lighting fixture 501. In some embodiments, step 611 may entail tightening screws (e.g., 117 and 147) of each descending-bracket (e.g., 105 and 135) of bracket ring 100, such that the descending-brackets (e.g., 105 and 135) removably clamp to recessed lighting fixture 501. In some embodiments, step 613 may be a step of crimping a second crimp 157, to secure a second terminal end 103 of first-structural-curved-member 101 of bracket ring 100 to another different terminal end 133 of second-structural-curved-member 131 of bracket ring 100. In some embodiments, upon completing step 613 (or upon completing a last step of steps 615), bracket ring 100 may be securely attached to recessed lighting fixture 501. In some embodiments, upon completing step 613 (or upon completing a last step of steps 615), bracket ring 100 may be removably and securely attached to recessed lighting fixture 501.

Note, separating crimping steps 607 and 611 from each other may facilitate step 611 (and step 609 discussed below) by permitting some movement in bracket ring 100.

Continuing discussing FIG. 6, in some embodiments, steps 615 may comprise step 601, which may proceed step 603. In some embodiments, step 601 may entail collapsing bracket ring 100 to a smallest configuration of central hole 165 of bracket ring 100 that may be smallest. Step 601 may facilitate the insertion step of step 603. Note, if bracket ring 100 is already sufficient collapsed to fit into lighting-module-hole 505 of recessed lighting fixture 501, then step 601 may be unnecessary.

Continuing discussing FIG. 6, in some embodiments, steps 615 may comprise step 609, which may proceed step 611. In some embodiments, step 607 of crimping the first crimp 157 may be followed by step 609 of securing upwards-protruding-tabs (e.g., 111 and 141) of fixed brackets (e.g., 107 and 137) of bracket ring 100 to a downward facing flange 503 of recessed lighting fixture 501. In some embodiments, step 609 of securing upwards-protruding-tabs may then be followed by step 611 of tightening the brackets (e.g., 105 and 135). Recessed lighting fixtures 501 without such downward facing flanges 503, do not require step 609.

Continuing discussing FIG. 6, in some embodiments, steps 625 may comprise: step 617, step 619, and step 621. In some embodiments, step 617 may be a step of passing a portion of lighting module 301 with torsion springs 201 into lighting-module-hole 505 of recessed lighting fixture 501. Step 617 may also entail passing portions of lighting module 301 into central hole 165. In some embodiments, step 619 may comprise securing each torsion spring 201 to a torsion-spring-receiver (e.g., 125 and 155) of bracket ring 100. This may entail the user squeezing each torsion-spring 201 to facilitate torsion-spring 201 fitting to the given torsion-spring-receiver (e.g., 125 and 155). In some embodiments, step 621 may comprise pushing the lighting module 301 further into lighting-module-hole 505 until lighting module 301 stops against a portion of recessed lighting fixture 501. At this point, the engaged torsion-springs 201 may help to guide this motion. Upon completing step 621, lighting module 301 may now be removably and securely attached to bracket ring 100.

Continuing discussing FIG. 6, in some embodiments, steps 639 may comprise: step 631, step 633, step 635, and step 637. In some embodiments, step 631 may be a step of turning off power to recessed lighting fixture 501. In some embodiments, step 631 may be a step of checking to make sure there is no power to recessed lighting fixture 501. In some embodiments, step 633 may be a step of removing an existing lighting module from recessed lighting fixture 501. In some embodiments, step 635 may be a step of inspecting recessed lighting fixture 501 and inspecting lighting-module-hole 505 of that recessed lighting fixture 501. This inspection step may be looking for potential hazards or problems. In some embodiments, step 637 may be a step of installing new connectors, if the inspection step 635 indicated new connections may be desired or necessary.

A retrofit bracket ring or bracket ring has been described, as well as systems using such a bracket ring, and methods of using and/or installing such bracket rings. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A bracket ring for coupling to a recessed lighting fixture and for providing structure to receive a lighting module, wherein the bracket ring comprises:
a first-structural-curved-member, that is a structural member, that is curved, has a pair of terminal ends, has a first-descending-bracket, and has a first-torsion-spring-receiver;
a second-structural-curved-member, that is another structural member, that is curved, has a pair of different terminal ends, a second-descending-bracket, and has a second-torsion-spring-receiver;
wherein the first-structural-curved-member and the second-structural-curved-member are coupled to each other at the pair of terminal ends overlapping with the pair of different terminal ends; wherein when the first-structural-curved-member and the second-structural-curved member are coupled to each other a central hole is formed; wherein this central hole is sized and shaped to accommodate a portion of the lighting module;
wherein the first-descending-bracket and the second-descending-bracket are coupled to different regions of the recessed lighting fixture; and
wherein when the portion of the lighting module is inserted into the central hole, torsion springs attached to the lighting module are removably received at the first-torsion-spring-receiver and at the second-torsion-spring-receiver, respectively, resulting in the lighting module being anchored to the bracket ring that is coupled to the recessed lighting fixture.

2. The bracket ring according to claim 1, wherein the first-structural-curved-member and the second-structural-curved-member are each substantially flat.

3. The bracket ring according to claim 1, wherein the first-structural-curved-member and the second-structural-curved-member are each shaped, from a top view, substantially as: a letter “C,” a horseshoe, a letter “U,” a semi-circle, or a semi-ellipse.

4. The bracket ring according to claim 1, wherein the pair of terminal ends of the first-structural-curved-member each extends upwards in a tab; wherein the pair of another terminal ends of the second-structural-curved-member each comprises a crimp; wherein when the first-structural-curved-member and the second-structural-curved member are coupled to each other, the tabs butting against the crimps prevent the first-structural-curved-member from becoming decoupled from the second-structural-curved-member.

5. The bracket ring according to claim 1, wherein the pair of another terminal ends of the second-structural-curved-member each comprises a crimp; wherein when the first-structural-curved-member and the second-structural-curved member are coupled to each other; tightening of the crimps against the first-structural-curved-member prevents sliding and fixes the first-structural-curved-member to the second-structural-curved-member.

6. The bracket ring according to claim 1, wherein the first-structural-curved-member and the second-structural-curved-member each comprises at least one slot in curved portions of the first-structural-curved-member and of the second-structural-curved-member.

7. The bracket ring according to claim 6, wherein the at least one slot of the first-structural-curved-member is the first-torsion-spring-receiver; and wherein the at least one slot of the second-structural-curved-member is the second-torsion-spring-receiver.

8. The bracket ring according to claim 1, wherein the first-torsion-spring-receiver and the second-torsion-spring-receiver are selected from: a slot or a C-clip.

9. The bracket ring according to claim 1, wherein when the first-structural-curved-member and the second-structural-curved member are coupled to each other, the first-torsion-spring-receiver and the second-torsion-spring-receiver are substantially opposed from each other.

10. The bracket ring according to claim 1, wherein when the first-structural-curved-member and the second-structural-curved member are coupled to each other, the first-descending-bracket and the second-descending-bracket are substantially opposed from each other.

11. The bracket ring according to claim 1, wherein when the first-structural-curved-member and the second-structural-curved member are coupled to each other forming the central hole, curved portions of the first-structural-curved-member and of the second-structural-curved member, and the central hole, all substantially share a common plane.

12. The bracket ring according to claim 11, wherein the first-descending-bracket and the second-descending-bracket both descend substantially perpendicularly away from the common plane.

13. The bracket ring according to claim 1, wherein both the first-descending-bracket and the second-descending-bracket each operate as a separate clamp to clamp onto the different regions of the recessed lighting fixture; wherein each of the first-descending-bracket and the second-descending-bracket comprises:
a fixed-bracket with protruding tabs, wherein the fixed-bracket is fixed to the first-structural-curved-member or is fixed to the second-structural-curved-member, respectively;
a slidable-bracket with different protruding tabs, wherein the slidable-bracket is slidingly coupled to the fixed-bracket;
wherein the protruding tabs of the fixed-bracket and the different protruding tabs of the slidable-bracket clamp opposing portions of the different regions of the recessed lighting fixture.

14. The bracket ring according to claim 13, wherein both the first-descending-bracket and the second-descending-bracket each further comprises a screw and a spring for adjustment of the separate clamp; wherein the screw and the spring are substantially concentric and collinear with each other; wherein the screw is coupled to both the fixed-bracket and the slidable-bracket; wherein turning of the screw lowers or raises the slidable-bracket in relation to the fixed-bracket.

15. The bracket ring according to claim 1, wherein both the first-descending-bracket and the second-descending-bracket each operate as a separate clamp to clamp onto the different regions of the recessed lighting fixture; wherein each of the first-descending-bracket and the second-descending-bracket comprises:
a fixed-bracket with protruding tabs that protrude substantially orthogonally away from a major longitude of the fixed-bracket, wherein the fixed-bracket also has upwards-protruding-tabs that extend upwards from a bottom of the fixed-bracket, wherein the fixed-bracket is fixed to the first-structural-curved-member or is fixed to the second-structural-curved-member, respectively, at a top of the fixed-bracket;
a slidable-bracket with different protruding tabs, wherein the slidable-bracket is slidingly coupled to the fixed-bracket;
wherein the upwards-protruding-tabs of the fixed-bracket and the different protruding tabs of the slidable-bracket clamp different portions of the different regions of the recessed lighting fixture.

16. The bracket ring according to claim 1, wherein the central hole, as viewed from a top view, is substantially shaped as: a circle, an ellipse, an oval, a number “0,” or a letter “O.”

17. The bracket ring according to claim 1, wherein the central hole is substantially concentric with a lighting-module-hole in the recessed lighting fixture.
